(19) United States
(12) Patent Application Publication
(10) Pub. No.: US 2022/0203280 A1
(43) Pub. Date: Jun. 30, 2022

(54) DIVERSION OF PRESSURIZED FLUID AND CONTROL IN A COMPRESSOR SYSTEM

(71) Applicant: Ingersoll-Rand Industrial U.S., Inc., Davidson, NC (US)

(72) Inventors: Christopher Taylor, Mooresville, NC (US); Sajesh Poolathody, Malappuram (IN); Patrick E. Schmitz, Huntersville, NC (US); Chandramouli Janaki Rama Sai Attili, Bengaluru (IN); Sunil Jayalakshmamma Munisubbaiah, Bangalore (IN)

(21) Appl. No.: 17/139,118

(22) Filed: Dec. 31, 2020

(51) Int. Cl. B01D 45/12; F16K 11/074; F16K 11/07; F16K 27/04

(52) U.S. Cl. CPC B01D 45/12; F16K 11/074; F16K 27/041; F16K 27/04; F16K 27/045; F16K 11/07

(57) ABSTRACT

A compressor system includes an inlet for receiving a fluid stream, a compressor in communication with the inlet, a separator in communication with the compressor, and a vent. The compressor system also includes a flow diversion control device in communication with the inlet, the compressor, the separator, and the vent, where the flow diversion control device has a first port in fluid communication with the separator, a second port in fluid communication with the inlet, a third port communicatively coupled with the inlet, a fourth port in fluid communication with the vent, and a mechanical valve having a first orientation configured to connect the first port to the second port and the third port to the fourth port for unloading the compressor system, and a second orientation configured to connect the first port to the third port and the second port to the fourth port for loading the compressor system.

### BACKGROUND

Generally, a compressor is a mechanical device that can increase the pressure of a gas by reducing its volume. Compressors and pumps can both increase the pressure on a fluid and transport the fluid.

### DRAWINGS

The Detailed Description is described with reference to the accompanying figures. The use of the same reference numbers in different instances in the description and the figures may indicate similar or identical items.

FIG. 1 is a diagrammatic illustration of a compressor system with a flow diversion control device in accordance with example embodiments of the present disclosure.

FIG. 2 is a diagrammatic illustration of a flow diversion control device for a compressor system, such as the compressor system illustrated in FIG. 1, where the flow diversion control device is shown in an unloading condition in accordance with example embodiments of the present disclosure.

FIG. 3 is a diagrammatic illustration of the flow diversion control device of FIG. 2, where the flow diversion control device is shown in a loading condition in accordance with example embodiments of the present disclosure.

FIG. 4 is a diagrammatic illustration of a sleeve for the flow diversion control device shown in FIG. 2 in accordance with example embodiments of the present disclosure.

FIG. 5 is a diagrammatic illustration of a sleeve housing for the flow diversion control device shown in FIG. 2 in accordance with example embodiments of the present disclosure.

FIG. 6 is a diagrammatic illustration of an actuation device for the flow diversion control device shown in FIG. 2 in accordance with example embodiments of the present disclosure.

FIG. 7 is a diagrammatic illustration of a flow diversion control device for a compressor system, such as the compressor system illustrated in FIG. 1, in accordance with example embodiments of the present disclosure.

FIG. 8 is a diagrammatic illustration of a spool for the flow diversion control device shown in FIG. 7 in accordance with example embodiments of the present disclosure.

FIG. 9 is a partial cross-sectional diagrammatic illustration of the flow diversion control device shown in FIG. 7 in accordance with example embodiments of the present disclosure.

FIG. 10 is a diagrammatic illustration of a flow diversion control device for a compressor system, such as the compressor system illustrated in FIG. 1 where the flow diversion control device is shown in an unpowered position in accordance with example embodiments of the present disclosure.

FIG. 11 is a diagrammatic illustration of the flow diversion control device of FIG. 10, where the flow diversion control device is shown in a powered position in accordance with example embodiments of the present disclosure.

FIG. 12 is a diagrammatic illustration of a flow diversion control device for a compressor system, such as the compressor system illustrated in FIG. 1 where the flow diversion control device is shown in an unpowered position in accordance with example embodiments of the present disclosure.

FIG. 13 is a diagrammatic illustration of the flow diversion control device of FIG. 12, where the flow diversion control device is shown in a powered position in accordance with example embodiments of the present disclosure.

### DETAILED DESCRIPTION

Systems, apparatus, and techniques are disclosed herein for diversion of pressurized fluid (e.g., pneumatic, hydraulic) and control in a compressor system. A flow diversion control valve can divert compressed air from one location to another location. This allows for inlet valve actuation control, inlet valve control modulation, air recirculation to the inlet, and/or venting air (e.g., to atmosphere and/or to depressurize the compressor system). The valve can be operated by a variety of mechanisms, including, but not necessarily limited to: an electric solenoid, a stepper motor, a pneumatic actuator, a hydraulic actuator, and so forth.

Compressor system controls can be used to reduce the output of individual compressor(s) during times of comparatively lower demand. Compressed air systems may be designed to operate within a fixed pressure range and to deliver air volume that varies with system demand. The system pressure can be monitored, and the control system can decrease the compressor output when the pressure reaches a predetermined level. Compressor output may then be increased again when the pressure drops to a lower predetermined level. Several different control strategies may be employed with compressor systems. For example, start/stop and/or load/unload controls can be used to respond to reductions in air demand, unloading a compressor so that air is not delivered for a period of time. Inlet modulation and multi-step controls can be used to operate a compressor at part-load and deliver a reduced amount of air during periods of reduced demand. Multiple valves can be used for both intake air control and recirculation control of compressed air back to the compressor intake of the compression module. Multiple valves may require large amounts of time and/or control calculations. Moreover, the complexity of a blowdown system may increase with larger machinery.

The systems, techniques, and apparatus described herein can reduce the number of components to be assembled, which may provide a reduction in leak paths, a reduction in costs, a reduction in assembly time, and/or a reduction in production costs. Additionally, the aesthetics and/or service time of the systems, techniques, and apparatus described herein may be improved as compared to other compressor systems. As described, a housing is used to manifold compressed air and divert the air to different locations (e.g., based upon a set of inputs). The arrangements described herein can decrease the complexity and overall size of a compressor system. Additionally, functionality can be improved by having a single valve to control rather than multiple valves (e.g., three or four valves).

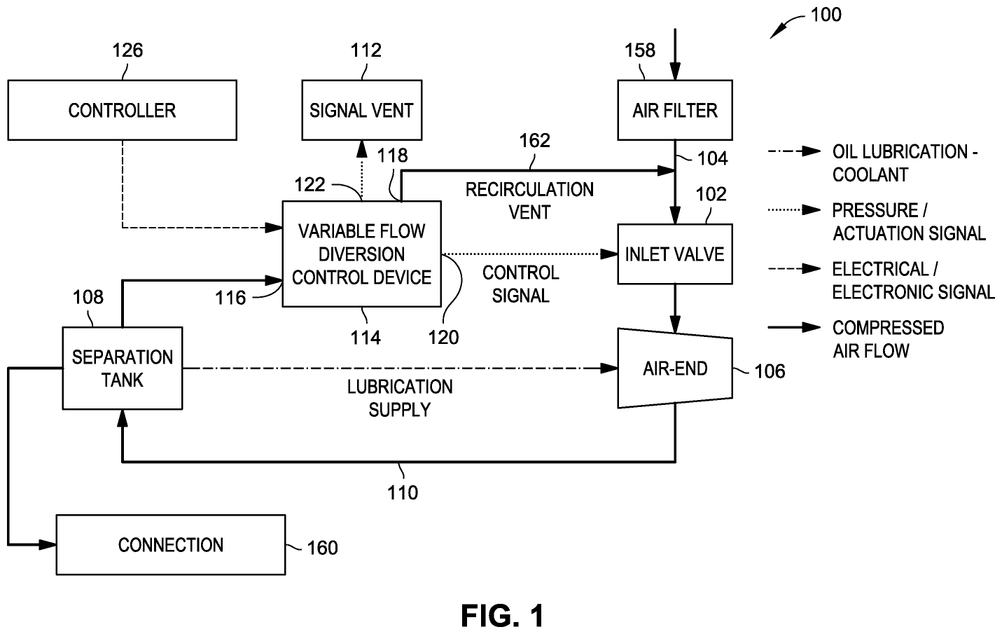

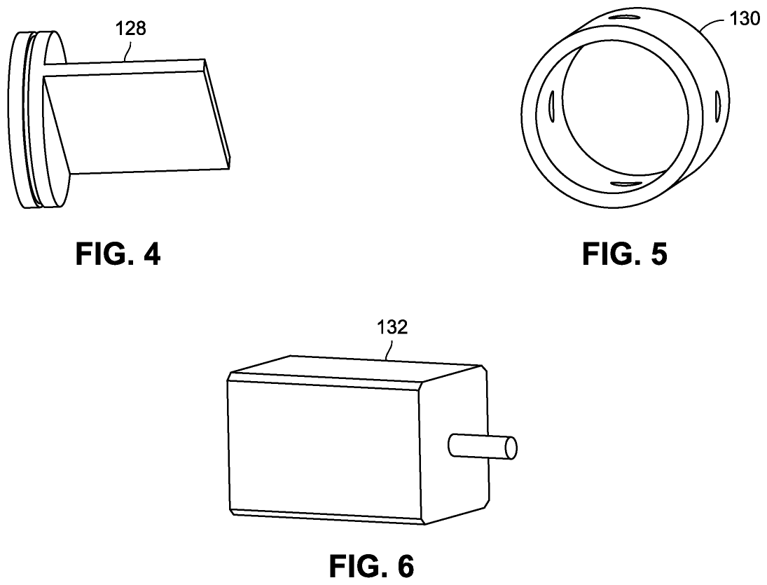

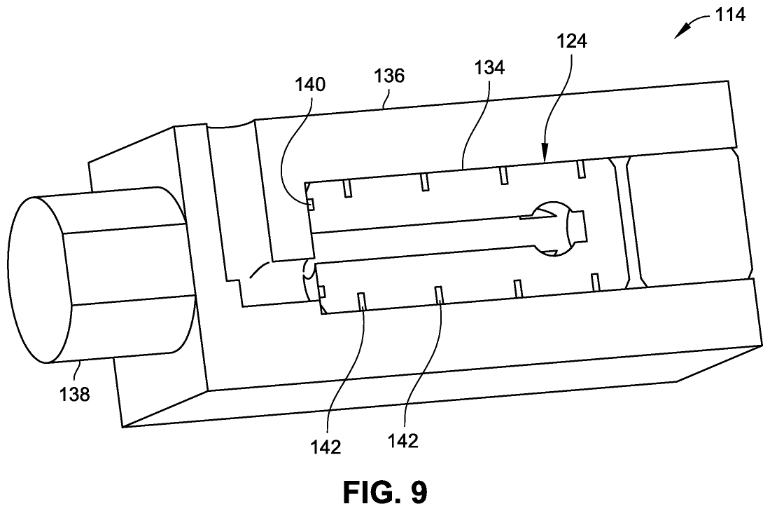

Referring generally to FIGS. 1 through 13, fluid displacement systems, such as compressor systems 100, are described in accordance with example embodiments of the present disclosure. A compressor system 100 includes an inlet 102 for receiving a fluid stream 104 to be displaced (e.g., compressed). The inlet 102 can be, for example, an inlet valve with an adjustable opening for controlling fluid flow (e.g., airflow) into the compressor system 100. The compressor system 100 also includes a fluid displacement device, such as a compressor 106 (e.g., an air-end, such as an oil flooded compression unit), in fluid communication with the inlet 102 for displacing (e.g., compressing) the fluid stream 104 and a separator 108 (e.g., a separation tank with an oil slinging device) in fluid communication with the compressor 106 for separating a first fluid component (e.g., oil) from the displaced/compressed fluid stream 110 and returning the oil to the compressor 106. The compressor system 100 further includes a vent 112 (e.g., a signal vent for depressurizing and/or internally venting the compressor system 100). It should be noted that while the present disclosure describes fluid displacement systems configured as compressor system 100 with some specificity, the systems, apparatus, and techniques of the present disclosure are not limited to compressor systems. For example, in some embodiments, a fluid displacement device of a fluid displacement system can be a pump, such as a hydraulic pump.

In embodiments of the disclosure, the compressor system 100 also includes a flow diversion control device 114 in fluid communication with the inlet 102, the compressor 106, the separator 108, and the vent 112. For example, the flow diversion control device 114 includes a solid body/housing with a first port 116 in fluid communication with the separator 108 (e.g., connected to a fluid signal pressure source, such as a separator tank connection), a second port 118 in fluid communication with the inlet 102 (e.g., connected to a vent to a compressor inlet), a third port 120 communicatively coupled with the inlet 102 (e.g., connected to a fluid pressure signal to compressor inlet valve), a fourth port 122 in fluid communication with the vent 112 (e.g., connected to venting for capacity control modulation), and a mechanical valve 124 (e.g., a butterfly valve, a spring loaded valve, and so forth, which may be pneumatically controlled, electrically controlled, and so on, as more fully described below).

The compressor system 100 can also include a controller 126 for actuating the mechanical valve 124 to fine tune and control the compressor system 100, e.g., based upon monitoring the discharge and/or air pressure of the compressor system 100. As described, diverting can be controlled by rotation, linear movement, linear and/or rotary pulse, and so forth. In embodiments of the disclosure, the mechanical valve 124 has a first orientation configured to connect the first port 116 to the second port 118 and the third port 120 to the fourth port 122 for unloading the compressor system 100 (e.g., providing pressure relief through recirculation), and a second orientation configured to connect the first port 116 to the third port 120 and the second port 118 to the fourth port 122 for loading the compressor system 100.

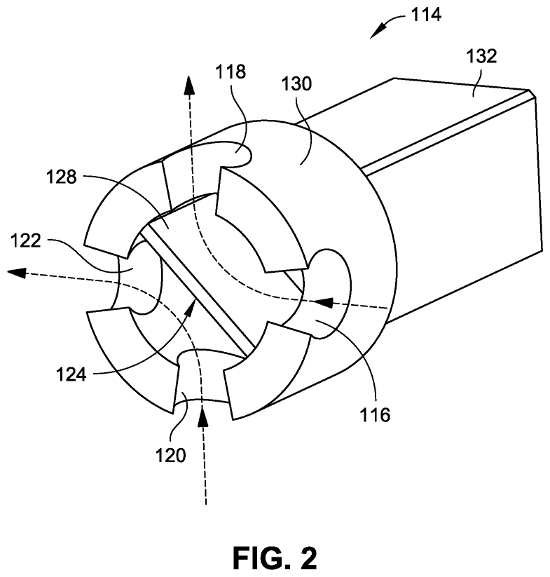

With reference to FIGS. 2 through 6, a compressor system 100 with a pressurized fluid diverter/fluid diversion control device 114 having a mechanical valve 124 configured as a rotating paddle sleeve is described, where the fluid diversion control device 114 has four (4) ports and two (2) positions. The compressor system 100 can control load-unload compressor operation by flow diversion control through ninety degrees (90°) of sleeve rotation. For example, the fluid diversion control device 114 has a sleeve 128, a sleeve housing 130, and an actuation device 132 (e.g., a stepper motor or rotary solenoid) for controlling the orientation of the sleeve 128. The compressor system 100 in this example has a normally closed (NC) inlet valve.

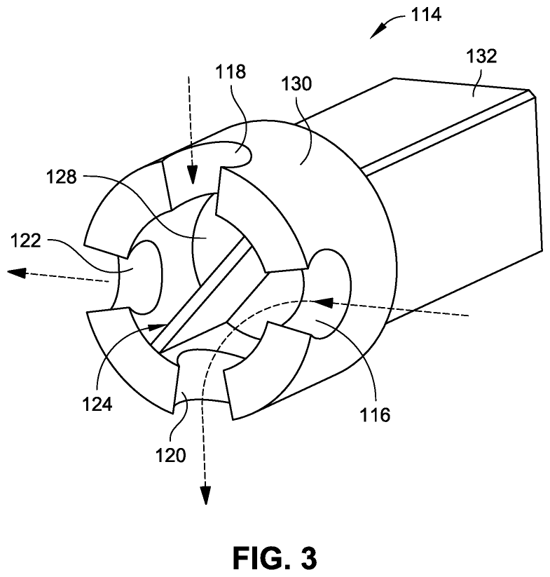

With reference to FIG. 2, an unpowered “home” position of the valve is shown where a torsional spring is used to connect port 120 to port 122 (NC inlet valve closed) and to connect port 116 to port 118 (separator tank vented). In this position, the compressor is unloaded when running and blowing down when stopped. With reference to FIG. 3, the valve is powered, resulting in a ninety-degree (90°) rotation of the sleeve 128 to connect port 116 to port 120 (signal pressure opens inlet valve and stops venting of the separator tank so compressor can be loaded) and to connect port 118 to port 122. In this position, the compressor 106 is loaded. As described herein, the sleeve rotation control can be performed by rotary solenoid coil(s) or stepper motor (e.g., depending upon cost and/or torque considerations). For example, a larger compressor application may require more torque than a smaller compressor application. In some embodiments, the housing is included with the inlet 102/inlet valve, e.g., based upon the architecture of the inlet valve body. It should be noted that while the discussion of FIGS. 2 and 3 describes a normally closed inlet valve, the systems, techniques, and apparatus of the present disclosure may also be used with inlet valves that are normally open. For example, with reference to FIGS. 2 and 3, port 118 can be communicatively coupled with the inlet 102, and port 120 can be in fluid communication with the inlet 102.

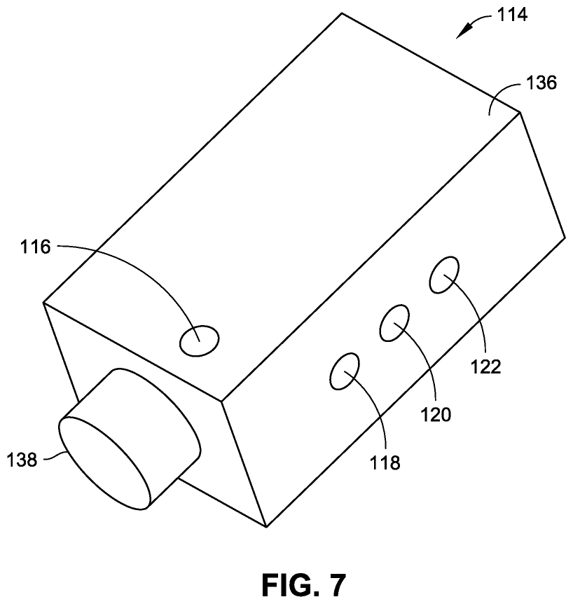

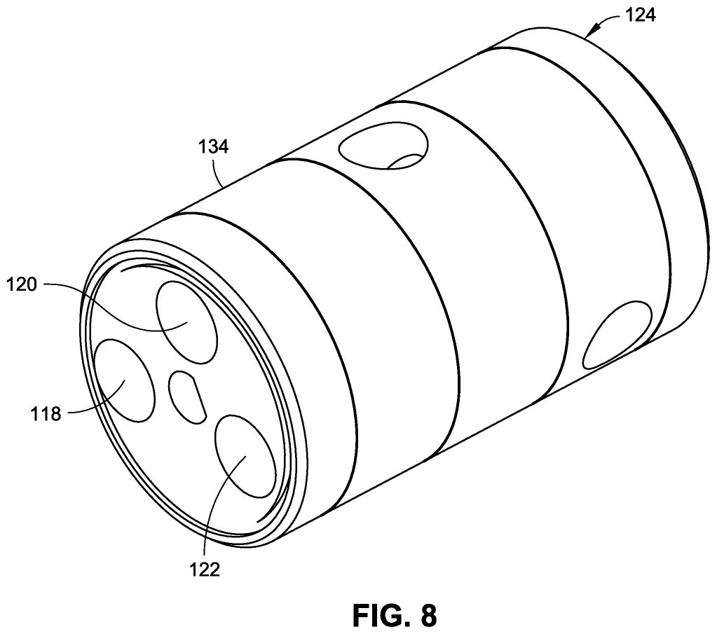

Referring now to FIGS. 7 through 9, a compressor system 100 with a pressurized fluid diverter/fluid diversion control device 114 having a mechanical valve 124 configured as a rotating barrel spool is described, where the fluid diversion control device 114 has four (4) ports and two (2) positions, with a third variable position range option. The compressor system 100 can control load-unload compressor operation by flow diversion control through a rotating spool 134 in a housing 136/air control block, where the spool 134 is coupled to an actuation device 138 (e.g., a rotary solenoid with, for example, a torsional spring). This example also includes a variable rotation feature that can reduce the compressor capacity by reducing the signal pressure to the inlet valve. The compressor 106 in this example has a normally closed inlet valve where the percentage open can be controlled by varying signal pressure. Port 116 is fed with compressed air from the separator 108, and, as the rotary solenoid rotates, different ports are connected at different angle increments.

At a first (unpowered) position (e.g., at zero degrees (0°) of rotation), port 116 is connected to port 118. At a second position (e.g., at one hundred and twenty degrees (120°) of rotation), port 116 is connected to port 120, causing the inlet valve to fully open. At a third position (e.g., at the next incremental one hundred and twenty degrees (120°) of rotation from the second position), port 116 is connected to port 122, which enables partial opening of the inlet valve through the proportional control valve. In some embodiments, the spool and housing slots have geometry configured to provide an at least approximately linear relationship between rotation angle and signal pressure. As described herein, the rotating barrel spool arrangement allows for varying restriction to control blowdown vent back pressure and pressure signal venting back pressure. The housing 136 and spool 134 can also include one or more axial seal(s) 140 and/or radial seal(s) 142 (e.g., O-rings and/or other sealing devices) at various interfaces therebetween.

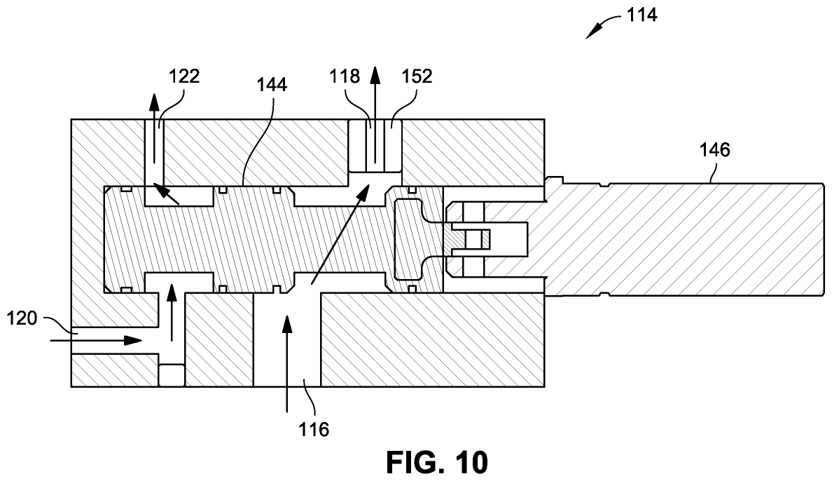

With reference to FIGS. 10 through 13, a compressor system 100 with a pressurized fluid diverter/fluid diversion control device 114 having a mechanical valve 124 configured as an axial spool is described, where the fluid diversion control device 114 has four (4) ports and two (2) positions, with a two-port variable position range option. The compressor system 100 can control load-unload compressor operation by flow diversion control through an “on-off” spool 144 coupled to a linear actuator 146 (e.g., a linear solenoid or another linear actuator) having movement in the axial direction with a return spring. In some embodiments, a second “modulation” spool 148 and a linear actuator 150 (e.g., a linear solenoid or another linear actuator) having a variable axial position feature reduces compressor capacity by reducing the signal pressure to the inlet valve. The compressor 106 in this example has a normally closed inlet valve where the percentage open can be controlled by varying the signal pressure. Port 116 is supplied with air from the separator 108 and, as the linear actuator 146 moves axially, it connects to different ports.

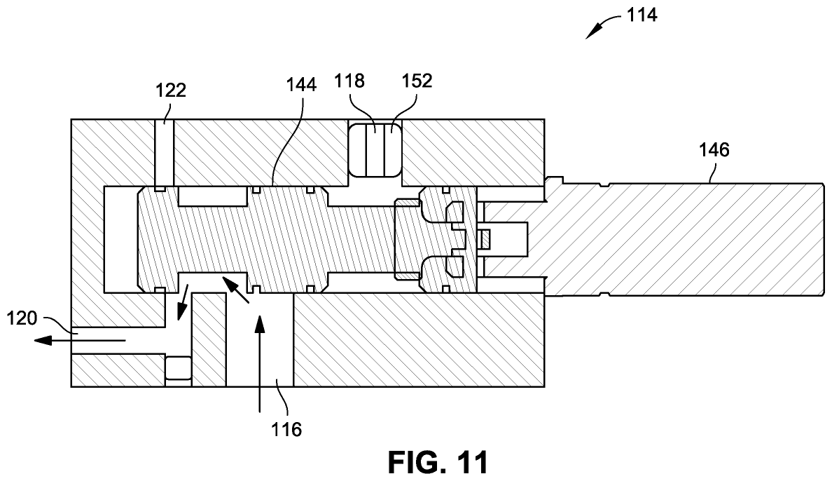

Referring now to FIG. 10, at a first unpowered position, port 116 is connected to port 118. In the linear actuator 146 off position, supply from the separator 108 is diverted to the blow down port 118. In some embodiments, the fluid diversion control device 114 includes a blow down adapter fitted with an orifice adapter 152, which can fit different adapter sizes. For example, different orifice sizes may be used (e.g., depending upon machine size). A pressure signal from port 120 is vented through port 122. In some embodiments, the linear actuator 146 is a variable stroke length solenoid valve. In these examples, the blowdown orifice may be eliminated, and the position of the spool 144 can be controlled to regulate the separator tank pressure. With reference to FIG. 11, at a second powered position, port 116 is connected to port 120, causing the inlet valve to open. In the solenoid on position, the solenoid switches position moving the spool 144. The port 118 blowdown vent is blocked and supply from the separator tank goes to port 120. The controller 126 can be used to control the linear actuator 146/solenoid.

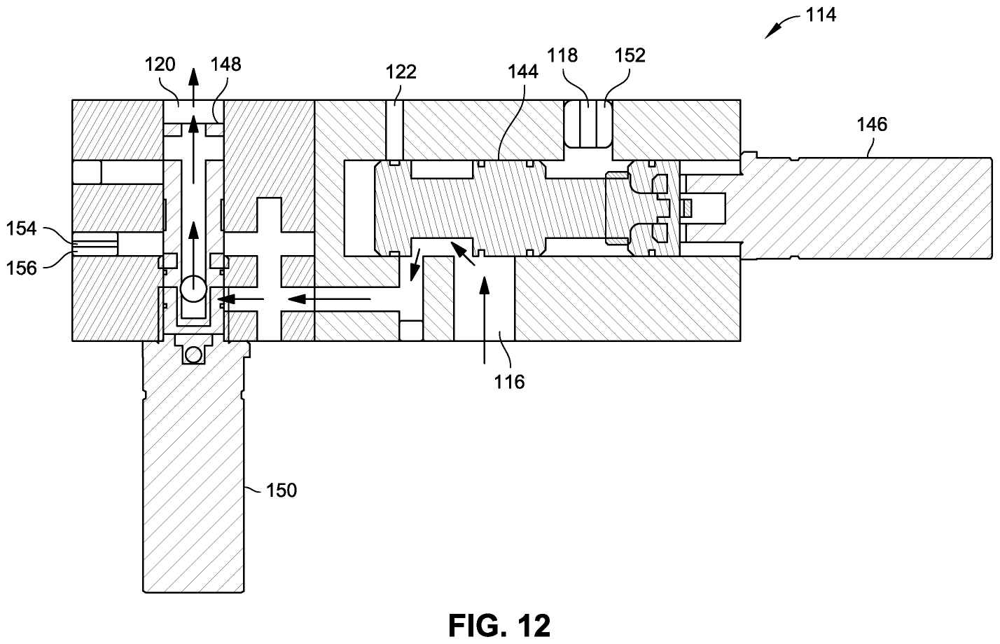

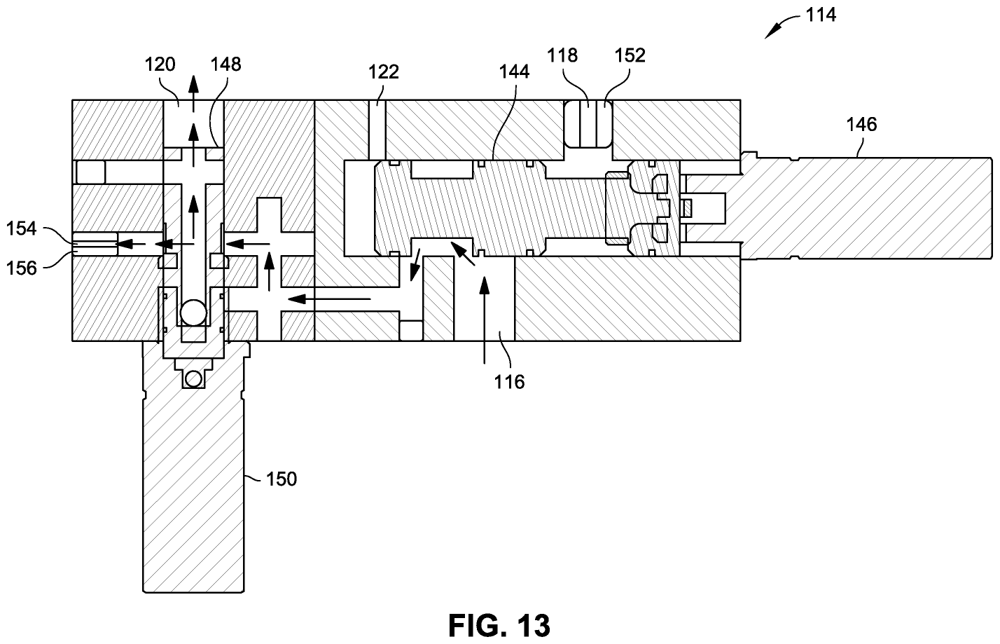

Referring now to FIG. 12, the modulation spool 144 is shown in an unpowered position, where the supply from the separator 108 (port 116) is directed to the “on-off” block pressure signal port (port 120). In this position, the linear actuator 146 is on and the linear actuator 150 is off. With the linear actuator 146 on, the supply from the separator tank (port 116) is connected to the on-off block pressure signal port (port 120). With the linear actuator 150 off, the on-off pressure signal enters the modulation block and passes through the spool 148 to port 120. With reference to FIG. 13, the modulation spool 148 can be placed in a range of positions, where port 120 is connected to the inlet valve and a fifth port 154 is partly opened to vent and/or reduce signal pressure to port 120. As the axial position changes, the amount of venting increases, reducing the port 120 signal pressure. The spool and housing geometry can allow for an at least approximately linear relationship between axial position and signal pressure. In this position, the linear actuator 146 is on and the linear actuator 150 is on (active). With the linear actuator 146 on, the supply from the separator tank (port 116) is connected to the on-off block pressure signal port (port 120), then to the modulation block, and then passes through the spool 148 to port 120. With the linear actuator 150 active, the position of the spool 148 can vent a portion of the signal pressure to port 122, reducing the signal pressure to port 120. In some embodiments, the modulation vent of the fluid diversion control device 114 is fitted with an orifice adapter 156, which can fit different adapter sizes. For example, different orifice sizes may be used (e.g., depending upon machine size).

As described herein, various solenoid valves can be used, including, but not necessarily limited to: push type or pull type solenoids, rod end and/or threaded solenoids, solenoids having from about five newtons (5 N) up to about two hundred newtons (200 N) of force, solenoids having strokes from about two millimeters (2 mm) up to about one hundred and twenty millimeters (120 mm), voltages of about twelve volts (12 V) or twenty-four volts (24 V) DC, voltages of about one hundred and ten volts (110 V), two hundred and twenty volts (220 V), or two hundred and thirty volts (230 V) AC, and so forth.

Referring to FIG. 1, the air in a compressor system 100 goes through multiple components to deliver compressed air. The air first passes through an air filtration system (e.g., an air filter 158). Once the air is filtered (e.g., for particulates), the air passes through an inlet control device (e.g., the inlet 102/inlet valve). In embodiments of the disclosure, the inlet control device can operate in multiple air control modes. Control modes include the following: load, unload (with recirculation), and suction throttling capacity control (optional).

When loaded, the controller 126 monitors the discharge pressure, measured at a connection 160. When a set point is reached, the compressor 106 goes into unload mode. When unloaded, the flow diversion control device 114 fully opens to direct the compressed air from the separator 108, through recirculation vent piping 162, to the inlet 102. The flow diversion control device 114 also closes the inlet control device, minimizing the airflow into the air-end/compressor 106. Once the system pressure drops below a set point, the compressor loads by flow diversion control device 114 opening the inlet control device and stopping the compressed air flow through the recirculation vent piping 162, allowing the system pressure to increase and deliver compressed air via the connection 160.

The recirculation vent piping 162 creates a restriction that maintains a minimum separation tank pressure for the oil lubrication system. The suction throttling capacity control option adjusts the open percentage of the inlet control device/inlet 102 to restrict air flow delivered to the air-end/compressor 106 based on the discharge pressure measured at the connection 160. In this manner, a stable discharge pressure range can be maintained, minimizing cycling of the compressor system 100, along with improved energy savings related to system response time. This option utilizes a proportionate control, where the percentage of control device opening depends on the discharge pressure within a range, e.g., about 10 pounds per square inch (psi) in some embodiments. Adjustments may be used to provide system stability. Discharge pressure above a desired target may indicate low demand, resulting in a reduced percent open and reduced compressor capacity. Discharge pressure below a desired target may indicate high demand, resulting in increased percent open of inlet control device and increased compressor capacity.

Another technique for capacity control is to use variable speed motors/drives for capacity control that have a larger turndown range than suction throttling capacity control systems, but are still limited due to the minimum allowable air end speeds. The systems, techniques, and apparatus of the present disclosure provide advantages over other compressor systems. For example, typical suction throttling control methods may consume large amounts of energy. For instance, when demand is low, discharge pressure is highest and pressure at the point of use is higher than needed. When demand is high, discharge pressure is low while the pressure at the point of use is at the minimum allowed. Furthermore, typical suction throttling control methods have a pressure control range that may be too wide for some applications. Additionally, air compressor systems using variable speed motors/drives for capacity control may not have sufficient capacity control bandwidth in some applications due to minimum capacity limitations.

In accordance with the present disclosure, the simplified componentry can reduce the quantity of potential leak paths, improving reliability of the air control system. Simplification of the componentry can decrease the total cost of the control system. Reduction of the controlled discharge pressure variation amplitude can improve operational stability. Simplification of componentry can decrease control device set-up and/or configuration time. Additionally, improved energy efficiency can reduce total system cycle energy.

As described, the systems, techniques, and apparatus of the present disclosure can provide the following operating control modes: load, unload (with recirculation), and suction throttling capacity control. With reference to the load and unload modes, recirculation control may be improved. For example, the separation tank pressure can be controlled by the positioning of an adjustable element, allowing for positional control of the recirculation opening based on the separation tank pressure. This can reduce or minimize unloaded power consumption and/or improve depressurization of the compressed air system. While improving the depressurization of the system, cycle energy can be reduced while also reducing impact to other system components. No special parts may be needed, as the control device can adjust the opening of the recirculation.

With reference to suction throttling capacity control modes, the percentage of inlet control device opening can be adjusted based upon a control signal from the compressor controller. For example, the compressor controller adjusts the control signal based on a set of inputs from the compressor system to regulate the discharge pressure to a specific target pressure. This control method allows for more precise and stable regulation of the compressor discharge pressure, and further total cycle energy reduction.

The systems, techniques, and apparatus of the present disclosure can also be applied to extend the capacity control range of variable speed compressors due to the more precise and stable regulation versus traditional proportional suction throttling capacity control systems. Consolidation of multiple components and control signals into a single control device that can operate multiple functions with a single signal can be provided, whereas existing control systems may require multiple components to open, close, partly close the suction control device, and blowdown the separator tank.

Referring again to suction throttling capacity control, circuitry can be added or removed without impacting the function of the load and unload operating modes. Further, suction throttling capacity control allows for throttling of the inlet control device based upon a set of inputs (e.g., to a microprocessor) to control the discharge pressure to a specific target versus a proportion control requiring a discharge pressure band. For example, circuitry converts the compressor controller's requested percent load electronic signal into a control signal (port 120) that controls the position of the inlet control device. Suction throttling compressor capacity control can be more stable and/or precise due to internal geometry that results in a more linear relationship between the discharge pressure, inlet control device percent closed position, and resulting compressor air flow delivered, resulting in a reduction of cycle energy by reducing the average discharge pressure over time.

When demand is low, the discharge pressure matches the target, set in the controller 126, instead of increasing to the high end of the pressure control band. This reduces wasted pressure at the point of use. When demand is high, the discharge pressure continues to match the target pressure, and pressure is maintained at the point of use, e.g., instead of dropping to the minimum of the pressure control range. This can reduce or eliminate the wasted energy of compressor overpressure during periods of decreased load. Additionally, cycle energy losses can be reduced or minimized by an improved speed of response to sudden demand changes. Further, more precise capacity control can be used to further reduce the rangeability of compressors using variable speed control. Enhanced recirculation control can be used to control the depressurization rate and separation tank pressure when changing from load to unload operation modes. This can provide one or more of the following benefits: reduced wear on system components, enabling control to minimize unintended effects in the tank during rapid depressurization, and/or a reduction in total cycle energy.

The systems, apparatus, and techniques of the present disclosure allow one control device to reduce complexity when compared to existing system parts performing the same tasks. A single control device can reduce the quantity of potential leak paths when compared to typical control systems. A single device can increase system reliability when compared to multiple components. Further, field commissioning and serviceability can be improved. For example, troubleshooting of the control system can be shortened due to a single control device that is replaceable in the field instead of having to analyze multiple components. This can eliminate rework from identifying the wrong root-cause of a problem. Further, commissioning of the control system can be shortened as a result of the target pressure set point in the controller, e.g., instead of manual adjustment of a pressure regulating device.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A compressor system comprising:
an inlet for receiving a fluid stream to be compressed;
a compressor in fluid communication with the inlet for compressing the fluid stream;
a separator in fluid communication with the compressor for separating oil from the compressed fluid stream and returning the oil to the compressor;
a vent; and
a flow diversion control device in fluid communication with the inlet, the compressor, the separator, and the vent, the flow diversion control device having
a first port in fluid communication with the separator,
a second port in fluid communication with the inlet,
a third port communicatively coupled with the inlet,
a fourth port in fluid communication with the vent, and
a mechanical valve having a first orientation configured to connect the first port to the second port and the third port to the fourth port for unloading the compressor system, and a second orientation configured to connect the first port to the third port and the second port to the fourth port for loading the compressor system.

2. The compressor system as recited in claim 1, wherein the mechanical valve is biased to the first orientation, and the inlet comprises a normally closed inlet valve.

3. The compressor system as recited in claim 1, wherein the mechanical valve is configured as a paddle sleeve valve.

4. The compressor system as recited in claim 1, wherein the mechanical valve is configured as a barrel spool valve.

5. The compressor system as recited in claim 1, wherein the mechanical valve is configured as an axial spool valve.

6. The compressor system as recited in claim 1, further comprising a modulation spool, wherein the first port is connected to the third port in the second orientation of the mechanical valve when the modulation spool is in an unpowered position, and the first port is connected to a fifth port in the second orientation of the mechanical valve when the modulation spool is in a powered position.

7. The compressor system as recited in claim 1, wherein the mechanical valve is actuated by an actuator configured to position the mechanical valve incrementally between the first orientation and the second orientation.

8. A fluid displacement system comprising:
an inlet for receiving a fluid stream;
a fluid displacement device in fluid communication with the inlet for displacing the fluid stream;
a separator in fluid communication with the fluid displacement device for separating a first fluid component from the displaced fluid stream and returning the first fluid component to the fluid displacement device;
a vent; and
a flow diversion control device in fluid communication with the inlet, the fluid displacement device, the separator, and the vent, the flow diversion control device having
a first port in fluid communication with the separator,
a second port in fluid communication with the inlet,
a third port communicatively coupled with the inlet,
a fourth port in fluid communication with the vent, and
a mechanical valve having a first orientation configured to connect the first port to the second port and the third port to the fourth port for unloading the fluid displacement system, and a second orientation configured to connect the first port to the third port and the second port to the fourth port for loading the fluid displacement system.

9. The fluid displacement system as recited in claim 8, wherein the fluid displacement device comprises a compressor for compressing the fluid stream.

10. The fluid displacement system as recited in claim 8, wherein the mechanical valve is biased to the first orientation, and the inlet comprises a normally closed inlet valve.

11. The fluid displacement system as recited in claim 8, wherein the mechanical valve is configured as a paddle sleeve valve.

12. The fluid displacement system as recited in claim 8, wherein the mechanical valve is configured as a barrel spool valve.

13. The fluid displacement system as recited in claim 8, wherein the mechanical valve is configured as an axial spool valve.

14. The fluid displacement system as recited in claim 8, further comprising a modulation spool, wherein the first port is connected to the third port in the second orientation of the mechanical valve when the modulation spool is in an unpowered position, and the first port is connected to a fifth port in the second orientation of the mechanical valve when the modulation spool is in a powered position.

15. The fluid displacement system as recited in claim 8, wherein the mechanical valve is actuated by an actuator configured to position the mechanical valve incrementally between the first orientation and the second orientation.

16. A method comprising:
receiving, by an inlet, a fluid stream to be compressed;
compressing, by a compressor, the fluid stream;
separating, by a separator, oil from the compressed fluid stream;
returning the oil to the compressor;
unloading, by a mechanical valve of a flow diversion control device, the compressor system by connecting a first port in fluid communication with the separator to a second port in fluid communication with the inlet and a third port communicatively coupled with the inlet to a fourth port in fluid communication with a vent; and
loading, by the mechanical valve of the flow diversion control device, the compressor system by connecting the first port to the third port and the second port to the fourth port.

17. The method as recited in claim 16, further comprising biasing the mechanical valve to the first orientation, wherein the inlet comprises a normally closed inlet valve.

18. The method as recited in claim 16, wherein the mechanical valve comprises at least one of a paddle sleeve valve, a barrel spool valve, or an axial spool valve.

19. The method as recited in claim 16, further comprising: connecting, by a modulation spool, the first port to the third port in the loading orientation of the mechanical valve when the modulation spool is in an unpowered position, and connecting, by the modulation spool, the first port to a fifth port in the loading orientation of the mechanical valve when the modulation spool is in a powered position.

20. The method as recited in claim 16, further comprising: positioning, by an actuator, the mechanical valve incrementally between the first orientation and the second orientation.
